(19) United States
(12) Patent Application Publication
(10) Pub. No.: US 2024/0300599 A1
(43) Pub. Date: Sep. 12, 2024

(54) Bicycle Saddle

(71) Applicant: WindNer Carbon Tech Co.,Ltd., Taichung City (TW)

(72) Inventor: Jyun Hao GONG, Taichung City (TW)

(21) Appl. No.: 18/591,955

(22) Filed: Feb. 29, 2024

(30) Foreign Application Priority Data
Mar. 9, 2023 (TW) 112108779

(51) Int. Cl. B62J 1/00; B62J 1/26

(52) U.S. Cl. CPC B62J 1/002; B62J 1/26

(57) ABSTRACT

The invention discloses a bicycle saddle comprising a rail straight section, a sitting part, a buffer part and a guide part, the sitting part is separated from the rail straight section; the buffer part has at least one cushion body capable of easily deforming under stress, and the cushion body is located between the rail straight section and the sitting part; the guide part is provided between the rail straight section and the sitting part, when an external force is exerted on the sitting part, the sitting part is guided by the guide part to displace from a first position to a second position along an actuation direction toward the rail straight section, and the cushion body is compressed by the sitting part to cause recoverable deformation. Accordingly, the bicycle saddle of the invention has both good actuation stroke stability and cushioning effect.

### FIELD OF THE INVENTION

The invention relates to bicycles, and more particularly to a bicycle saddle.

### DESCRIPTION OF THE RELATED ART

Taiwan's utility model patent M343621 discloses a carbon fiber saddle. The saddle made of carbon fiber has characteristics of both light and rigid. However, in the patent, unequal wall thicknesses are also used. The design allows the saddle to deform partially and moderately. However, the carbon fiber saddle still has the problem of being too rigid, which can easily make the rider feel uncomfortable when riding. Moreover, the processing and manufacturing procedures of conventional carbon fiber materials are lengthy and the materials cannot be easily recycled and reused. Therefore, the manufacturers engaged in this industry need to strive to make improvement to solve the above-mentioned problems and drawbacks in the prior art.

### SUMMARY OF THE INVENTION

A main object of the invention is to provide a bicycle saddle capable of providing appropriate cushioning and anti-shock effects to improve the discomfort of conventional carbon fiber saddles when riding.

In order to achieve the above object, a bicycle saddle disclosed by the invention mainly comprises a rail straight section, a sitting part, a buffer part and a guide part, wherein the sitting part is separated from the rail straight section; the buffer part has at least one cushion body capable of easily deforming under stress, and the cushion body is located between the rail straight section and the sitting part; the guide part is provided between the rail straight section and the sitting part, when an external force is exerted on the sitting part, the sitting part is guided by the guide part to displace from a first position to a second position along an actuation direction toward the rail straight section, and the cushion body is compressed by the sitting part to cause recoverable deformation, thereby the bicycle saddle has both good actuation stroke stability and cushioning effect.

In one embodiment, the cushion body is located on a path defined by an actuation stroke of the sitting part between the first position and the second position guided by the guide part to provide cushioning and restoring elasticity for the sitting part.

In one embodiment, the bicycle saddle further comprises at least one first end portion and at least one second end portion, wherein the first end portion is disposed on a side of the sitting part facing the rail straight section; the second end portion is disposed on a side of the rail straight section facing the sitting part according to a position of the first end portion and along an extension direction of the path; the cushion body has a first end face and a second end face opposite to each other, the cushion body is located between the first end portion and the second end portion, the first end face of the cushion body is partially abutted against the first end portion, and the second end face of the cushion body is partially abutted against the second end portion.

In one embodiment, the cushion body comprises a buffer layer, and the first end face and the second end face are respectively located on two opposite sides of the buffer layer.

In one embodiment, the cushion body comprises an air bag, and the first end face and the second end face are respectively located on two opposite outer surfaces of the air bag.

In one embodiment, a material of the cushion body is urethane, silicone or thermoplastic polyurethane.

In one embodiment, the guide part has at least one guide unit, the guide unit comprises a guide hole and a guide rod, wherein the guide hole corresponds to a position of the first end portion and penetrates the rail straight section along the actuation direction; the guide rod corresponds to a position of the second end portion and is disposed on a side of the sitting part facing the rail straight section, and extends a predetermined length along the actuation direction toward the rail straight section and is inserted into the guide hole to slide therein to limit the actuation stroke of the sitting part between the first position and the second position.

In one embodiment, in order to achieve objects of convenient assembly and quick disassembly, the guide rod has a tube body with an internal thread formed on an inner wall surface thereof; a fastener is inserted into the guide hole from a side of the rail straight section not facing the sitting part, and is threadly connected with the internal thread of the tube body to connect the sitting part with the rail straight section.

In one embodiment, in order to enable the bicycle saddle to swing as a rider pedals to reduce pedaling resistance, the sitting part comprises two plates and a nose, wherein the two plates are spaced apart from each other by a predetermined distance; the nose is bridged between the two plates.

In one embodiment, a quantity of the first end portion is three, respectively located at appropriate positions of the two plates and the nose; a quantity of the second end portion is three, respectively corresponding to a position of each of the first end portions, and respectively located at appropriate positions of the rail straight section; a quantity of the guide unit is three, respectively provided between each of the first end portions and each of the second end portions.

In one embodiment, a quantity of the cushion body is three, respectively corresponding to a position of each of the guide units, and respectively located between each of the first end portions and each of the second end portions.

In one embodiment, the sitting part further comprises a peripheral wall provided at peripheries of the plates and the nose and extending a predetermined length along the actuation direction toward the rail straight section, the peripheral wall, the plates and the nose define an accommodation space, and the cushion body is configured according to a contour of the sitting part to be accommodated in the accommodation space.

In one embodiment, a material of the sitting part is composed of carbon fiber and thermoplastic resin, the thermoplastic resin is selected from at least one or a combination of a group consisting of polyamide, polypropylene, polyphenylene sulfide, polycarbonate and thermoplastic polyurethane.

In one embodiment, the rail straight section has a rail, and a material of the rail is selected from at least one or a combination of a group consisting of dry winding carbon fiber and thermoplastic carbon fiber (Carbon Fiber Reinforced Thermo-Plastic, CFRTP).

### BRIEF DESCRIPTION OF DRAWINGS

FIG. 1 is a perspective assembly view of a first embodiment of the invention.

FIG. 2 is a perspective view of FIG. 1 from another viewing angle.

FIG. 3 is an exploded perspective view of the first embodiment of the invention.

FIG. 4 is a cross-sectional view along section line 4-4 of FIG. 1.

FIG. 5 is a cross-sectional view of actuation of FIG. 4.

FIG. 6 is a cross-sectional view of a second embodiment of the invention.

FIG. 7 is a perspective assembly view of a third embodiment of the invention.

FIG. 8 is an exploded perspective view of the third embodiment of the invention.

FIG. 9 is a side view of a cushion body of the third embodiment of the invention.

FIG. 10 is a cross-sectional view of the third embodiment of the invention.

### DETAILED DESCRIPTION OF THE INVENTION

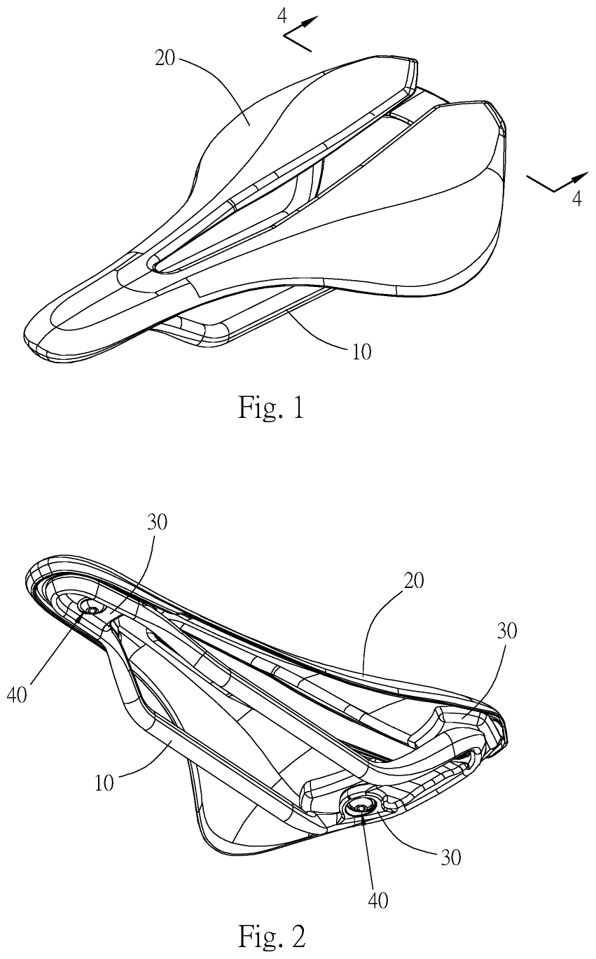

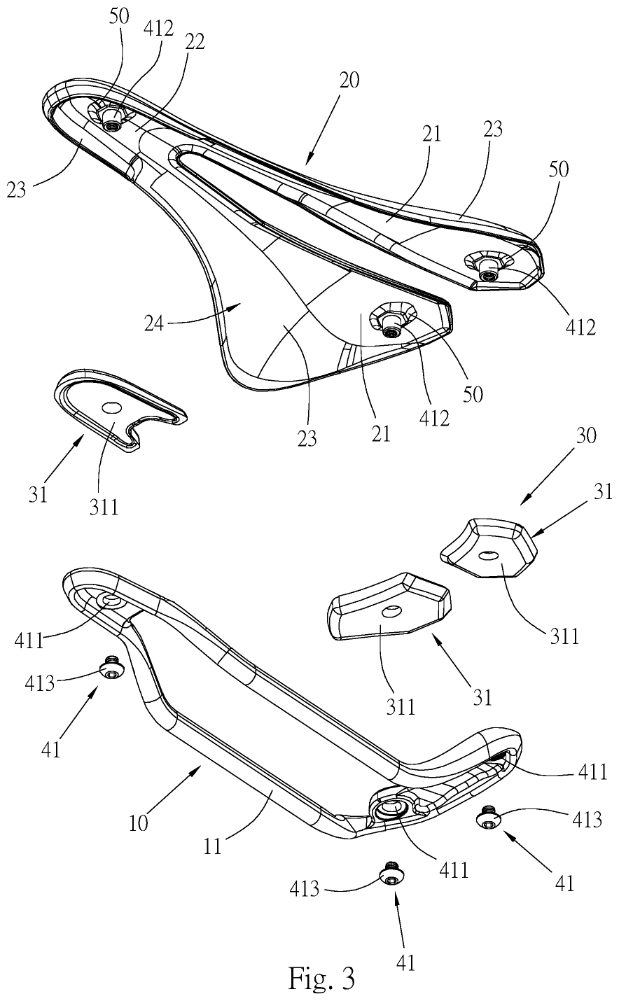

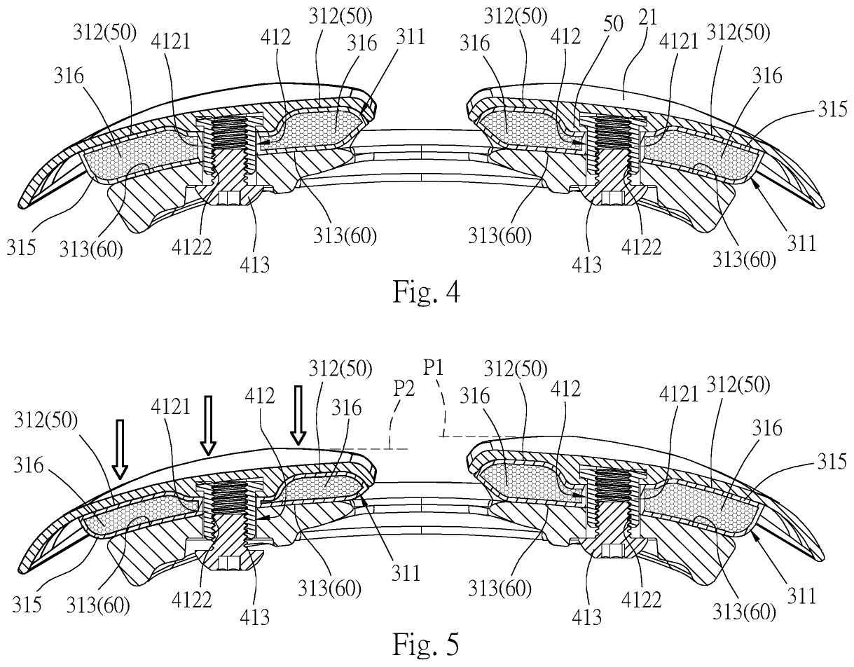

Please refer to FIGS. 1 to 5, which show a bicycle saddle disclosed in a first embodiment of the invention. The bicycle saddle comprises a rail straight section 10, a sitting part 20, a buffer part 30 and a guide part 40.

The rail straight section 10 is a base, which can be used as a basis for construction of other components of the invention. Specifically, the rail straight section 10 has a rail 11 with a frame structure, and its material is dry winding carbon fiber or thermoplastic carbon fiber (Carbon Fiber Reinforced Thermo-Plastic, CFRTP), wherein the rail straight section 10 formed by hot pressing of dry winding carbon fiber can be a cylinder, a cone, a sphere, an ellipsoid, or products with specific curvatures capable of improving limitation that conventional composite materials, especially carbon fiber materials, and conventional carbon fiber winding technology can only produce straight circular tubes.

The sitting part 20 is separated from the rail straight section 10, and comprises two plates 21, a nose 22 and a peripheral wall 23, wherein the nose 22 is in the form of a plate structure and serves as a connecting part, and is bridged between the two plates 21 so that the two plates 21 are separated by a predetermined distance. Specifically, a shape of each of the plates 21 is mirrored and symmetrically designed along a center line L to match a user's buttocks and ischium, a plate surface width of each of the plates 21 extends from narrow to wide along the center line L from a connection position with the nose 22, so that each of the plates 21 can bear part of a weight of the user's body.

The peripheral wall 23 is provided at peripheries of the plates 21 and the nose 22 and extends a predetermined length along an actuation direction toward the rail straight section 10, and the peripheral wall 23, the plates 21 and the nose 22 define an accommodation space 24.

Furthermore, the plates 21, the nose 22 and the peripheral wall 23 are integrally formed by hot pressing, and their materials are composed of carbon fiber and thermoplastic resin, so that the sitting part 20 can have appropriate support, load-bearing capacity and structural strength, and can be easily recycled and reused to produce other sub-structural products, improving a problem that conventional carbon fiber products cannot be recycled and reused. Wherein the thermoplastic resin is selected from at least one or a combination of a group consisting of polyamide, polypropylene, polyphenylene sulfide, polycarbonate and thermoplastic polyurethane; the carbon fiber can be selected from, but is not limited to carbon fiber recycled materials.

In addition, the two plates 21 and the nose 22 are respectively provided with a first end portion 50 at an appropriate position on a side facing the rail straight section 10, and a second end portion 60 corresponding to a position of each of the first end portions 50 is respectively disposed at an appropriate position on a side of the rail 11 facing the sitting part 20.

The guide part 40 is disposed between the rail straight section 10 and the sitting part 20. When an external force is applied to the sitting part 20, the sitting part 20 is guided by the guide part 40 to displace from a first position P1 to a second position P2 along an actuation direction toward the rail straight section 10. In this embodiment, the guide part 40 has three guide units 41, which are respectively provided between each of the first end portions 50 and each of the second end portions 60. Specifically, each of the guide units 41 comprises a guide hole 411, a guide rod 412 and a fastener 413, wherein the guide hole 411 corresponds to a position of the first end portion 50 and penetrates the rail straight section 10 along the actuation direction. The guide rod 412 has a tube body 4121 with an internal thread 4122 formed on an inner wall surface thereof, wherein one end of the tube body 4121 corresponds to a position of the second end portion 60 and is disposed on a side of the sitting part 20 facing the rail straight section 10, another end of the tube body 4121 extends a predetermined length along the actuation direction toward the rail straight section 10 and is inserted into the guide hole 411 to slide therein to limit an actuation stroke of the sitting part 20 between the first position P1 and the second position P2. Furthermore, the fastener 413 is inserted into the guide hole 411 from a side of the rail straight section 10 not facing the sitting part 20, and is threadly connected with the internal thread 4122 of the tube body 4121 to connect the sitting part 20 with the rail straight section 10. In this embodiment, the guide rod 412 is a nut, and the fastener 413 is a bolt.

The buffer part 30 has three cushion bodies 31, which are respectively located at appropriate positions in the accommodation space 24, each of the cushion bodies 31 has a buffer layer 315, and two opposite sides of the buffer layer 315 are respectively a first end face 312 and a second end face 313. The buffer layer 315 has a plurality of pores 316 therein, which are adjacent to each other in pairs and are not communicated with each other. Each of the pores 316 is circular, rectangular, polygonal or in honeycomb shape. Accordingly, when the buffer layer 315 is compressed, the pores 316 provide a margin for deformation of the buffer layer 315. Specifically, each of the cushion bodies 31 is located on a path defined by the actuation stroke of the sitting part 20 between the first position P1 and the second position P2 guided by the guide part 40. Each of the cushion bodies 31 is disposed between each of the first end portions 50 and each of the second end portions 60, the first end face 312 of the cushion body 31 is partially abutted against the first end portion 50, and the second end face 313 of the cushion body 31 is partially abutted against the second end portion 60 to provide cushioning and restoring elasticity for the sitting part 20. Furthermore, in this embodiment, each of the cushion bodies 31 is specifically an annular structure for the corresponding guide rod 412 to pass through.

With composition of the above-mentioned components, specific actuation of the bicycle saddle disclosed by the invention is described as follows.

Firstly, when the user is riding a bicycle, as the user's feet pedal on different pedals of the bicycle, the user's left and right buttocks press downward on the corresponding plates 21 respectively to enable each of the plates 21 to swing between the first position P1 and the second position P2 relative to the nose 22, as shown in FIG. 5, in order to reduce pedaling resistance.

Furthermore, as each of the plates 21 swings, the corresponding cushion body 31 is compressed to provide appropriate cushioning and anti-shock effects, thereby improving the discomfort of conventional carbon fiber saddles when riding.

In addition, the bicycle saddle of the invention further has good replaceability. According to different road conditions or bicycle types, the fastener 413, the sitting part 20 and the buffer part 30 can be removed and replaced with the other appropriate sitting part 20 and buffer part 30. For example, on a hilly road with flat road conditions, the other sitting part 20 in an overall shape with a raised tail is replaced, and the other buffer part 30 with a harder shock-absorbing effect is used.

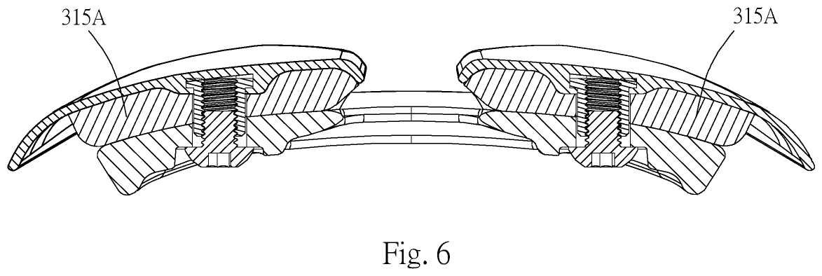

Furthermore, the bicycle saddle according to a second embodiment of the invention is shown in FIG. 6. A main difference between the second embodiment and the first embodiment is that each buffer layer 315A is a solid structure, and a material of the buffer layer 315A is composed of urethane, silicone or thermoplastic polyurethane capable of deforming under stress and restoring to its original shape after a force is removed to provide appropriate shock absorption effect.

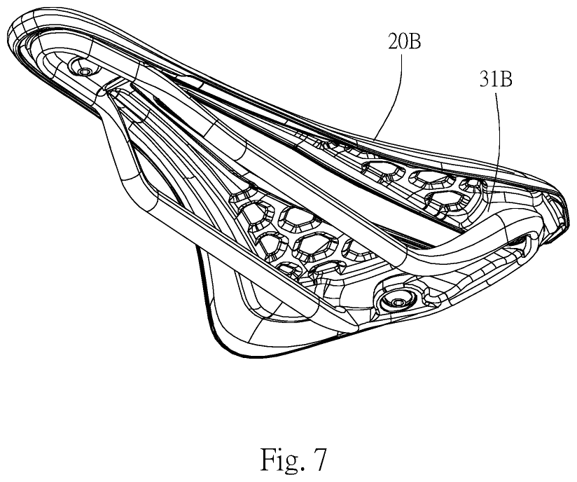

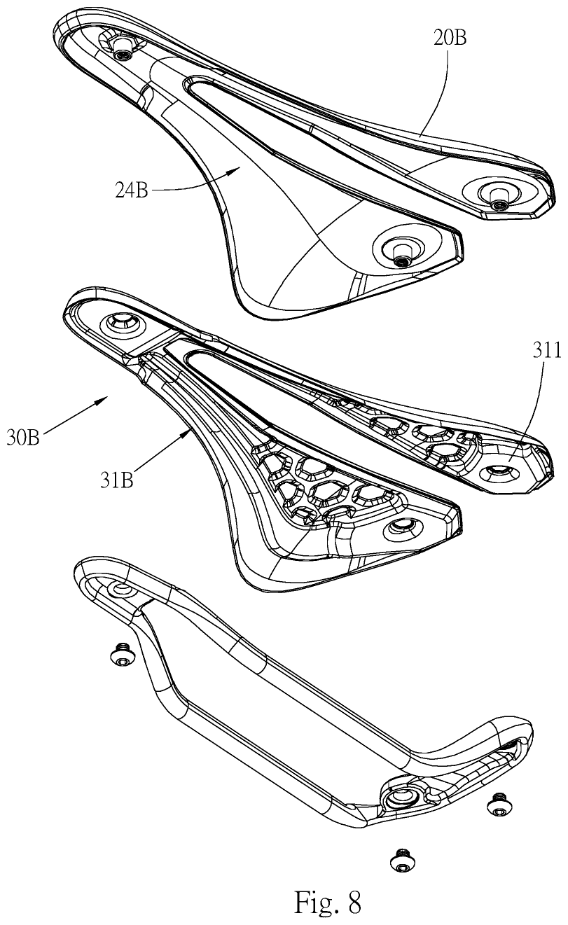

Continuing from FIGS. 7 to 10, the bicycle saddle is disclosed according to a third embodiment of the invention. A main difference between the third embodiment and the first embodiment is that a buffer part 30B only has a cushion body 31B, and the cushion body 31B is configured according to an overall contour of a sitting part 20B to be accommodated in an accommodation space 24B. Moreover, the cushion body 31B comprises an air bag 311, two opposite outer surfaces of the air bag 311 are a first end face 312B and a second end face 313B, and a chamber 314 is provided inside the air bag 311, which can be filled with appropriate pounds of gas to provide shock absorption required for different degrees of hardness. Furthermore, a material of the air bag 311 is composed of polyurethane, silicone, thermoplastic polyurethane or other elastic materials, and urethane can be used as polyurethane. Therefore, the air bag 311 is capable of easily deforming under stress, and restoring to its original shape after a force is removed.

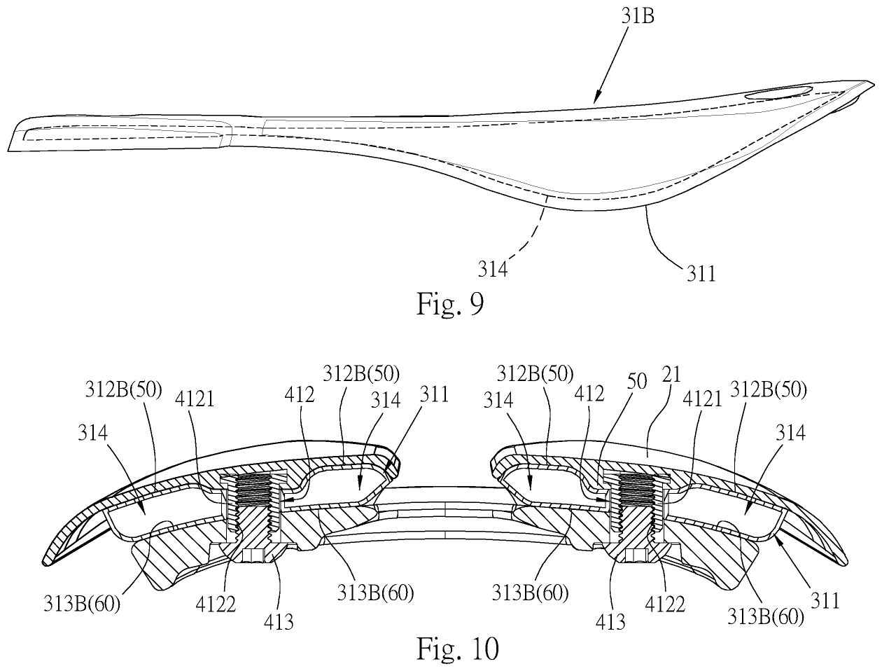

Further, as shown in FIG. 9, since the air bag 311 of the cushion body 31B only has the single chamber 314, after the chamber 314 is filled with gas, a same shock absorption effect is provided at any position, which improves differences in shock-absorbing feedback that may be caused by different elastic coefficients or elastic fatigue in conventional bicycle saddles that use springs as shock-absorbing components. In other feasible implementation modes, the air bag 311 can also be provided with the chambers 314, and the chambers 314 are communicated to one another by a ventilation tube to meet the aforementioned requirements. In addition, in other cases, the chambers 314 can further be configured independently without communicating with one another.

Although the invention has been disclosed as above with the embodiments, it is not intended to limit the invention. A person having ordinary skill in the art to which the invention pertains can make various changes and modifications without departing from the spirit and scope of the invention. Therefore, scope of protection of the invention shall be subject to what is defined in the pending claims.

What is claimed is:

1. A bicycle saddle comprising:
a rail straight section;
a sitting part separated from the rail straight section;
a buffer part having at least one cushion body capable of easily deforming under stress, and the cushion body being located between the rail straight section and the sitting part; and
a guide part provided between the rail straight section and the sitting part, when an external force being exerted on the sitting part, the sitting part being guided by the guide part to displace from a first position to a second position along an actuation direction toward the rail straight section, and the cushion body being compressed by the sitting part to cause recoverable deformation.

2. The bicycle saddle as claimed in claim 1, wherein the cushion body is located on a path defined by an actuation stroke of the sitting part between the first position and the second position guided by the guide part to provide cushioning and restoring elasticity for the sitting part.

3. The bicycle saddle as claimed in claim 2, further comprising:
at least one first end portion disposed on a side of the sitting part facing the rail straight section;
at least one second end portion disposed on a side of the rail straight section facing the sitting part according to a position of the first end portion and along an extension direction of the path; and
the cushion body having a first end face and a second end face opposite to each other, the cushion body being located between the first end portion and the second end portion, the first end face of the cushion body being partially abutted against the first end portion, and the second end face of the cushion body being partially abutted against the second end portion.

4. The bicycle saddle as claimed in claim 3, wherein the cushion body comprises a buffer layer, and the first end face and the second end face are respectively located on two opposite sides of the buffer layer.

5. The bicycle saddle as claimed in claim 3, wherein the cushion body comprises an air bag, and the first end face and the second end face are respectively located on two opposite outer surfaces of the air bag.

6. The bicycle saddle as claimed in claim 1, wherein a material of the cushion body is urethane, silicone or thermoplastic polyurethane.

7. The bicycle saddle as claimed in claim 2, wherein a material of the cushion body is urethane, silicone or thermoplastic polyurethane.

8. The bicycle saddle as claimed in claim 3, wherein a material of the cushion body is urethane, silicone or thermoplastic polyurethane.

9. The bicycle saddle as claimed in claim 3, wherein the guide part has at least one guide unit, the guide unit comprises:
a guide hole corresponding to a position of the first end portion and penetrating the rail straight section along the actuation direction; and
a guide rod corresponding to a position of the second end portion and disposed on a side of the sitting part facing the rail straight section, and extending a predetermined length along the actuation direction toward the rail straight section to insert into the guide hole to slide therein to limit the actuation stroke of the sitting part between the first position and the second position.

10. The bicycle saddle as claimed in claim 9, wherein the guide rod has a tube body with an internal thread formed on an inner wall surface thereof; a fastener is inserted into the guide hole from a side of the rail straight section not facing the sitting part, and is threadly connected with the internal thread of the tube body to connect the sitting part with the rail straight section.

11. The bicycle saddle as claimed in claim 10, wherein the sitting part comprises:
two plates spaced apart from each other by a predetermined distance; and
a nose bridged between the two plates.

12. The bicycle saddle as claimed in claim 8, wherein the sitting part comprises:
two plates spaced apart from each other by a predetermined distance; and
a nose bridged between the two plates.

13. The bicycle saddle as claimed in claim 11, wherein a quantity of the first end portion is three, respectively located at appropriate positions of the two plates and the nose; a quantity of the second end portion is three, respectively corresponding to a position of each of the first end portions, and respectively located at appropriate positions of the rail straight section; a quantity of the guide unit is three, respectively provided between each of the first end portions and each of the second end portions.

14. The bicycle saddle as claimed in claim 13, wherein a quantity of the cushion body is three, respectively corresponding to a position of each of the guide units, and respectively located between each of the first end portions and each of the second end portions.

15. The bicycle saddle as claimed in claim 11, wherein the sitting part further comprises a peripheral wall provided at peripheries of the plates and the nose and extending a predetermined length along the actuation direction toward the rail straight section, the peripheral wall, the plates and the nose define an accommodation space, and the cushion body is configured according to a contour of the sitting part to be accommodated in the accommodation space.

16. The bicycle saddle as claimed in claim 1, wherein a material of the sitting part is composed of carbon fiber and thermoplastic resin, the thermoplastic resin is selected from at least one or a combination of a group consisting of polyamide, polypropylene, polyphenylene sulfide, polycarbonate and thermoplastic polyurethane.

17. The bicycle saddle as claimed in claim 1, wherein the rail straight section has a rail, and a material of the rail is selected from at least one or a combination of a group consisting of dry winding carbon fiber and thermoplastic carbon fiber (Carbon Fiber Reinforced Thermo-Plastic, CFRTP).
